(19) United States
(12) Patent Application Publication
(10) Pub. No.: US 2001/0032210 A1
(43) Pub. Date: Oct. 18, 2001

(54) Method and apparatus for research management

(76) Inventors: Gregory Daniel Frank, Palo Alto, CA (US); Gregor Gimmy, San Francisco, CA (US); Diana Laird, Menlo Park, CA (US); Genes Sotto, Daly City, CA (US); David Zapol, Menlo Park, CA (US)

Correspondence Address: COOLEY GODWARD LLP, Attention: Patent Group, Five Palo Alto Square, 3000 El Camino Real, Palo Alto, CA, 94306-2155, US

(21) Appl. No.: 09/775,196

(22) Filed: Jan. 31, 2001

Related U.S. Application Data
(60) Provisional application No. 60/179,219, filed on Jan. 31, 2000.

(51) Int. Cl. G06F 17/30; G06F 12/14

(52) U.S. Cl. 707/104.1; 707/9; 707/203; 707/10; 705/26

(57) ABSTRACT

A method of managing scientific research includes receiving first protocol information from a first user, where the first protocol information specifies a scientific method. The first protocol information is stored in a scientific knowledge database. A request is accepted from a second user for the first protocol information. The first protocol information is transmitted to the second user. Modified first protocol information is obtained from the second user. The modified first protocol information is incorporated into the scientific knowledge database as second protocol information.

### BRIEF DESCRIPTION OF THE INVENTION

This invention relates to a computer-based, networked system for managing scientific research and other research-based endeavors.

### BACKGROUND OF THE INVENTION

For a scientist, research comprises scientific discussions with peers and co-workers, setting up and conducting laboratory experiments, exchanging feedback, remaking work or results known to the scientific community, either verbally or through written means, and exchanging knowledge. One key aspect of a scientist's research is the development, execution, evaluation, and exchange of protocols, data and other research information.

Protocols are instructions that define scientific methods. Protocols are a key research tool. They are used by the entire scientific community. They serve as essential blueprints for the scientist for day-to-day operations. The protocol is to the scientist as the recipe is to the chef or home cook. Every time a scientist does an experiment, he or she follows a protocol, a series of steps that will lead to a particular outcome. A protocol can be, for example, how to extract DNA from mammalian cells, the visualization of molecules on a population of cells, or the creation of a transgenic mouse.

Almost everything the scientific researcher does in the laboratory is accomplished by following a protocol. These protocols are shared, revised, improved and passed from person to person. Protocols exist primarily as handwritten or photocopied paper-documents scattered amongst universities and commercial labs. Scientists lose precious research time and money finding, storing and replicating protocols. Versioning, maintaining and navigating multiple versions of a given protocol, is a challenge. In addition, protocols are a primary driver of laboratory purchases, because they specify precisely all products needed to conduct an experiment.

Protocols are shared, revised, improved and passed from person to person. Knowledge is shared amongst individuals, labs, Universities and companies around the world. Protocols exist primarily as handwritten or photocopied paper-documents in which critical notes are often scribbled in the margins by the scientist. These critical scribbles often can effect whether an experiment is successful or not.

An example of how an individual scientist typically obtains a protocol is as follows:

1. The individual scientist asks coworkers if they have protocol X.

2. One coworker indicates that a researcher down the hall has performed protocol X.

3. The scientist then inquires into the whereabouts of the researcher down the hall to find out that he changed labs.

4. The scientist then speaks with the researcher's boss, who points to a stack of loose papers the researcher left behind and in which protocol X may be.

5. The scientist then sorts through the stack of papers and locates protocol X, which may be a photocopied document with illegible scribbles and calculations, presumably written by the researcher.

6. The scientist then returns to the lab, and spends time and money to acquire all the necessary ingredients and equipment needed to carry out protocol X.

This scenario would have been worse if the scientist and researcher were located in different parts of the world, for example. This example shows the need for an organized networked system that allows individual scientists and labs worldwide to share their knowledge efficiently and effectively.

Another means for sharing knowledge and protocols is through publications. Scientists publish articles summarizing their results in scientific journals, such as Science, Cell and Nature. A requirement of publishing in scientific journals is that scientists must provide written description of the methods used to obtain the results contained in the published report. This description should contain sufficient detail so that all procedures can be repeated by others in the scientific community. In addition, scientists share their results at scientific meetings, through talks, poster presentations and abstracts. Whether the scientist shares the knowledge through an article, talk, poster presentation or abstract, the scientist is required to tell an audience which protocols were used to obtain the results. Though this is an important requirement, the protocols used are only briefly mentioned, often leaving out valuable information. Thus, resulting in yet another barrier to the exchange of knowledge and the advancement of science.

As described above, an efficient means of disseminating protocols does not exist. This is due to a lack of an organized way for scientists to communicate with each other. This results in wasted time and money.

Another problem associated with existing scientific techniques is that once a scientist finds a desired protocol, ingredients and equipment are often not well described. Thus, the scientist spends additional time consulting with coworkers or searching through catalogs to find a vendor who sells the product, contacting the vendor, and frequently not receiving the best price for the product. If the scientist uses the wrong ingredient or equipment, time and money are lost.

Scientists must verify their results by repeating the same experiment a statistically significant number of times. In order to replicate an experiment, it is desirable to obtain ingredients from the same vendor, as the same ingredient from a different vendor may differ in quality, purity or efficiency. Thus, precise knowledge of the ingredient is important.

In addition, protocols are constantly changing, allowing the researcher to conduct the experiment, assay or task in a more efficient and successful manner. Thus, ingredients and equipment cited within the protocol will also change and the scientist must have access to this information.

Yet another problem with existing scientific methods is the lack of “real time” interaction between scientists at different locations. “Real time” interaction can be characterized as having the person standing next to you or across a phone line. Interactions can include exchanging protocols, exchanging ideas, giving feedback or setting up collaborations. Community interaction can be enhanced through “real time” interaction allowing innovation to be accelerated.

In view of the foregoing, it would be highly desirable to provide an improved technique for managing research. In particular, it would be highly desirable to provide an improved technique for controlling and disseminating protocol information and related scientific knowledge.

### SUMMARY OF THE INVENTION

The invention includes a scientific research management system with a scientific knowledge database to store protocol information including a set of protocols, each protocol specifying a scientific method. An access control module allows a first portion of the scientific knowledge database to be accessed by a first set of users and a second portion of the scientific knowledge database, larger than the first portion, to be accessed by a second set of users, where the second set of users is smaller than the first set of users.

The invention also includes a method of managing scientific research. The method includes receiving first protocol information from a first user, where the first protocol information specifies a scientific method. The first protocol information is stored in a scientific knowledge database. A request is accepted from a second user for the first protocol information. The first protocol information is transmitted to the second user. Modified first protocol information is obtained from the second user. The modified first protocol information is incorporated into the scientific knowledge database as second protocol information.

### DESCRIPTION OF THE DRAWINGS

FIG. 1 is a schematic overview of an embodiment of the system of the invention;

FIG. 2 is a protocol entry screen that may be used in accordance with an embodiment of the invention;

FIG. 3 is an exemplary screen display showing a retrieved protocol obtained in accordance with an embodiment of the invention;

FIG. 4 is a portion of a screen showing updates to a protocol entered in accordance with an embodiment of the invention;

FIG. 5 is a schematic representation of a protocol's history as defined in accordance with an embodiment of the invention;

FIG. 6 is an exemplary screen illustration showing links to other protocols, which may be used in accordance with an embodiment of the invention;

FIG. 7 illustrates a protocol ranking system used in accordance with an embodiment of the invention;

FIG. 8 illustrates a screen showing a protocol's browsing history provided in accordance with an embodiment of the invention;

FIG. 9 illustrates information from an individual's private “notebook” supplied in accordance with an embodiment of the invention;

FIG. 10 is an illustration of a search screen utilized in accordance with an embodiment of the invention;

FIG. 11 is an illustration of a search result screen that may be used in accordance with an embodiment of the invention; and

FIG. 12 illustrates purchasing events facilitated in accordance with an embodiment of the invention.

### DETAILED DESCRIPTION OF THE INVENTION

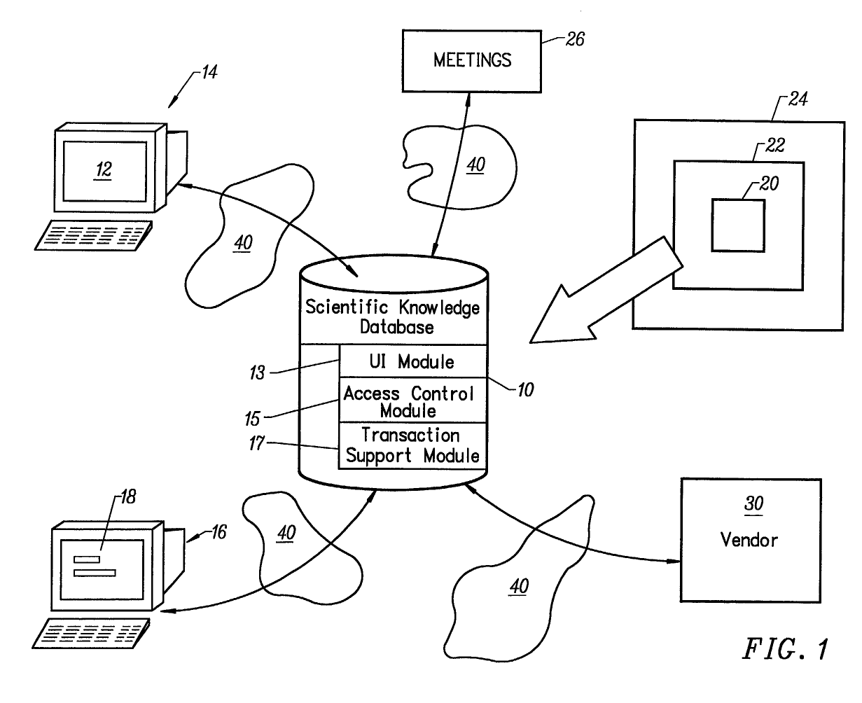

The method and system of the invention facilitates the creation of a multilayer protocol and scientific knowledge database. The invention allows for the entry of protocols into a database, the assignment of a protocol ID number for each entered protocol, the rating and ranking of protocols in the database, the versioning of protocols, and enables the provision of different layers of access into the database. An overview of the invention is shown schematically in FIG. 1.

FIG. 1 shows a central database 10, which is sometimes referred to as a scientific knowledge database. The database 10 is typically a relational database, with associated XML and/or other documents and information sources. Protocol information is input into the database through the input screen 12 of personal computer 14. Input screen 12 is a customized input screen, the details of which are described below. The input screen or user interface is preferably delivered to the personal computer 14 through a web browser.

Executable computer code in the form of a user interface module 13 operates to supply the input screen and process information received from the input screen using well known techniques. Once the input is complete, the protocol information is stored in a number of discreet fields within the database 10.

In addition to the user interface module 13, the database preferably includes other exectuable procedures or methods. For example, an access control module 15 incorporated into the database monitors access by various individuals to different information in the database, as discussed below. A transaction support module 17 facilitates the purchase of items specified in a protocol, as discussed below.

Protocol information is retrieved, for example, by a different user accessing the database 10 using personal computer 16. On the display screen of personal computer 16, a special purpose search form 18 is displayed. Preferably, the search form 18 is supplied by the user interface module 13. The search form 18 allows easier access and retrieval of the protocol data from the database 10. This screen and the access technique are described below.

Typically a user of computer 16 would access the protocol, use the protocol, and input information about the protocol into database 10. This information can be of many forms. It could, for example, be a development or an updated form of the protocol, in which case the user of computer 16 would be entering a new protocol. This new protocol is linked to the original protocol, but is reflected as an updated protocol. Alternatively, the user of computer 16 could leave feedback for the originator of the protocol (in this example, the user of the computer 14). Such feedback could be by e-mail and, depending on the design of the system, could be in a form of a private communication or a more broadly disseminated communication.

The user of the computer 16 can also rate the protocol. Such rating would depend on factors such as the usefulness of the protocol, the clarity of its description, etc. This rating information is then processed by the system, as described in greater detail below, to develop a rating and a later ranking for this protocol. Rating and ranking of protocols is useful to give later users of the protocol a sense of how “tried and tested” the protocol is.

The system also allows for restricting access to the database 10 into different “views.” Access to the database 10 is coordinated by the access control module 15. For example, the general public could have a view 20 of the database, which is to a subset of the total data saved. A select group of users, for example, a group of collaborators, may have a larger view 22 of the data saved on the database 10. This could typically happen when the collaborators associated with view 22 have saved information beyond the publicly available protocols (those viewed by the general public as view 20) on the database 10. The collaborators with view 22 may, for example, have saved their own proprietary protocols, comments and/or notes or other information on the database 10. These proprietary protocols, comments/notes, and the like are not accessible to the general public through “view” 20.

Similarly, a single individual of the collaborators may have a larger view 24 of information saved on the database. This individual would be able to view all the information that is publicly available as well as all the information saved by the members of the collaboration group. This individual may also have saved further proprietary and/or personal information that would be shielded from either the collaboration group with view 22 or the public as a whole with view 20.

The system can also be used to coordinate meetings 26 of members of collaboration groups (such as those with view 22) or larger, unbounded groups. As such, the system allows for a chat room environment in which people of like interests can share and, if appropriate, save information of interest, or set up collaborations. In addition, the system of the invention allows for “bulletin boards” in which information can be posted and read, vendor “booths” in which products can be displayed, and conferencing, such as teleconferences.

Also, once a user of computer 14 or computer 16 has decided that a certain selected protocol is to be used, the system can allow that user to place an order for materials directly with vendors 30. Placing and fulfilling an order is coordinated by the transaction support module 17.

Finally, as is apparent from FIG. 1, communications from computers 14 and 16 as well as other computers and with vendors can be through a network 40, typically the Internet or a corporate Intranet.

Individual inventive components and their interactions have now been introduced. Attention now turns to a more detailed description of these individual components and their interactions. The database 10 is typically a relational database, such as a database provided by ORACLE®, SYBASE® or mySQL®. In one embodiment, the documents stored and versioned in the database are saved and annotated following a standardized protocol XML DTD (eXtensible Markup Language Data Type Definition). This allows for the standardized exchange of protocol information between databases, and allows scientists to use the information according to their personal needs.

The database has a number of fields, arranged in different tables or sub-databases as appropriate. Examples of database fields are: Unique Protocol Identifier (UPI); Subject/Field, for example, Anatomy, Biology, Biochemistry, Bioengineering, Bioinformatics, Biophysics, Cell Biology, Cell Physiology, Clinical Diagnostics, Chemistry, Organic Chemistry, Inorganic Chemistry, Developmental Biology, Pharmacology, Ecology, Field studies, Genetics, Immunology, Medicine, Molecular Biology, Microbiology, Neuroscience, Pharmacology and Plant Biology; Technique, for example, arrays, blotting, cloning, electrophoresis, expression systems, genome walking, hybridization, ligation, purification of RNA, Polymerase Chain Reaction, sequencing, transformation, transfection, vector construction; Key Word; Author and Author contact information; Institution and Institution contact information; Year; Publication and Publication contact information; Pages; Vendors and Vendor contact information; Products; Rating; Ranking; Unique Protocol History (UPH); and Entering Protocol.

As is evident from the description above, protocols can be obtained from various sources. Examples are, a scientist, a publishing company, a vendor (a kit protocol), or a journal. Each protocol specifies a scientific method. Protocols come in various forms. They could, for example, instruct a researcher how to perform an assay, conduct an experiment, analyze results, use a piece of equipment, perform clinical trials or administer a drug. These are merely examples of the different types of protocols that can be managed by the system of the invention. In general, the techniques of the invention are applicable to any type of structured data.

In addition, protocols are not only written records of a process, much of the details of the process are often transmitted through personal demonstration. Thus, protocols can be in the form of multi-media presentations, such as video representations with voice explanations and/or animations. These forms of information could, for example, be stored in a separate database on a video file server or other suitable storage device.

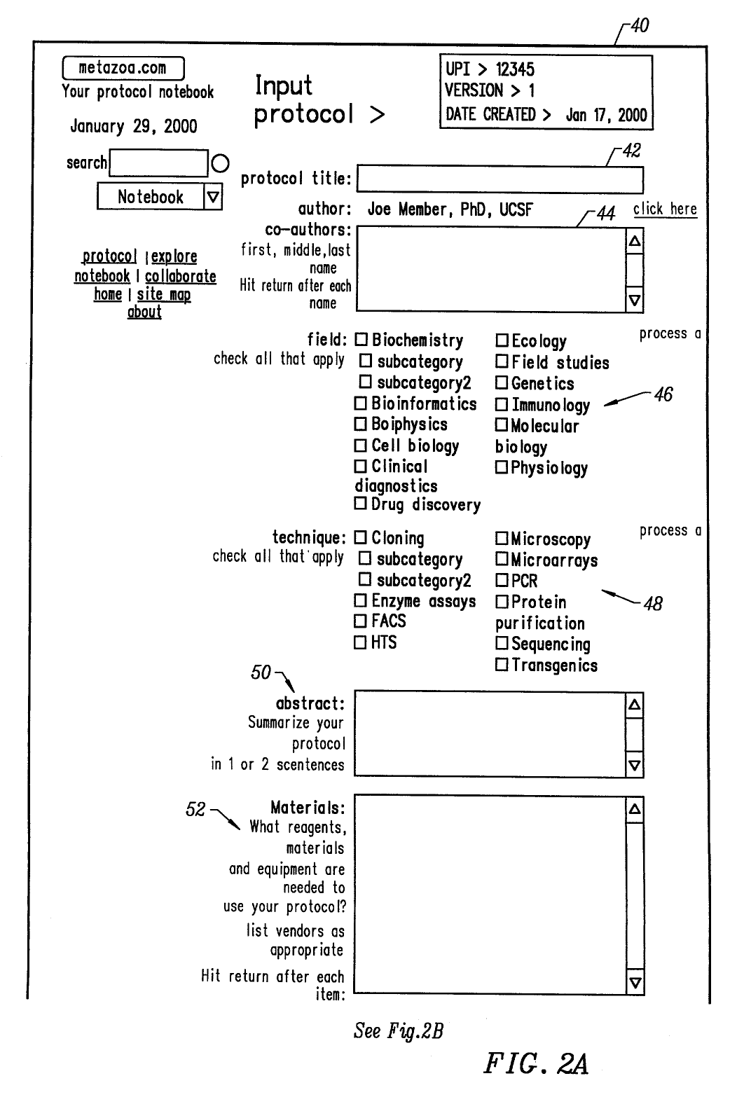

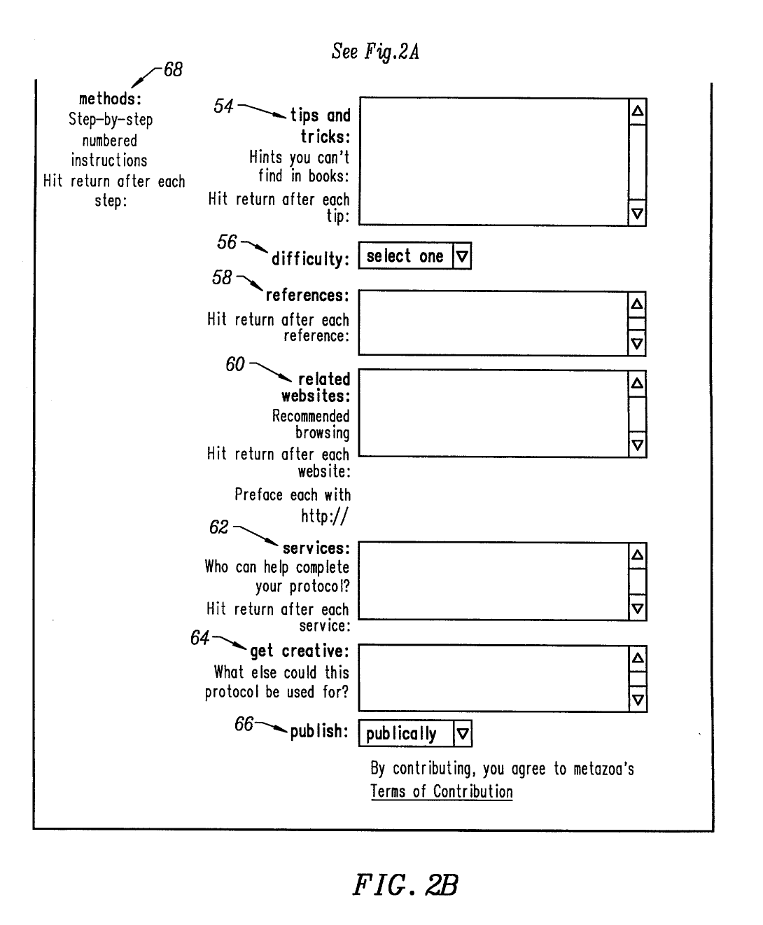

Each protocol may be entered in the same manner, making protocol entry easier and more efficient. An example of a protocol entry screen is shown in FIG. 2. The entry screen may be delivered from the user interface module 13 to a client computer 14 running a web browser. A researcher can start, for example, by typing in the title of the protocol into window 42 and proceeding down the screen 41.

Preferably, each protocol has a visibility level, for example, public or restricted. The visibility level may be specified at the time of entering the protocol and may be subsequently changed. Restricted protocols are accessible by the author or authorized group, for example, a research group. A scientist can make a protocol accessible to the public and a personal profile will appear on the face of the protocol.

Typical protocol information that can be captured is reflected in FIG. 2. This information can include: protocol title 42, co-authors 44, fields 46, technique 48, abstract 50, materials 52, tips and tricks 54, difficulty 56, references 58, related web sites 60, services 62, get creative 64, publish 66, and methods 68. Examples of additional protocol information that can be captured are: e-mail address, title, institution name, institution type, password (which can be verified), gender, date of birth, education, occupation, street, city, state, zip code, category, and other types of information.

When a protocol is entered, the system preferably assigns the protocol a Unique Protocol Identifier (UPI) or a Unique Protocol Label (UPL). The protocol numbering system is, for example, an incremental one starting with UPI 2001. Each submitted protocol is assigned a distinct UPI, regardless of whether the protocol is classified as publicly available or not.

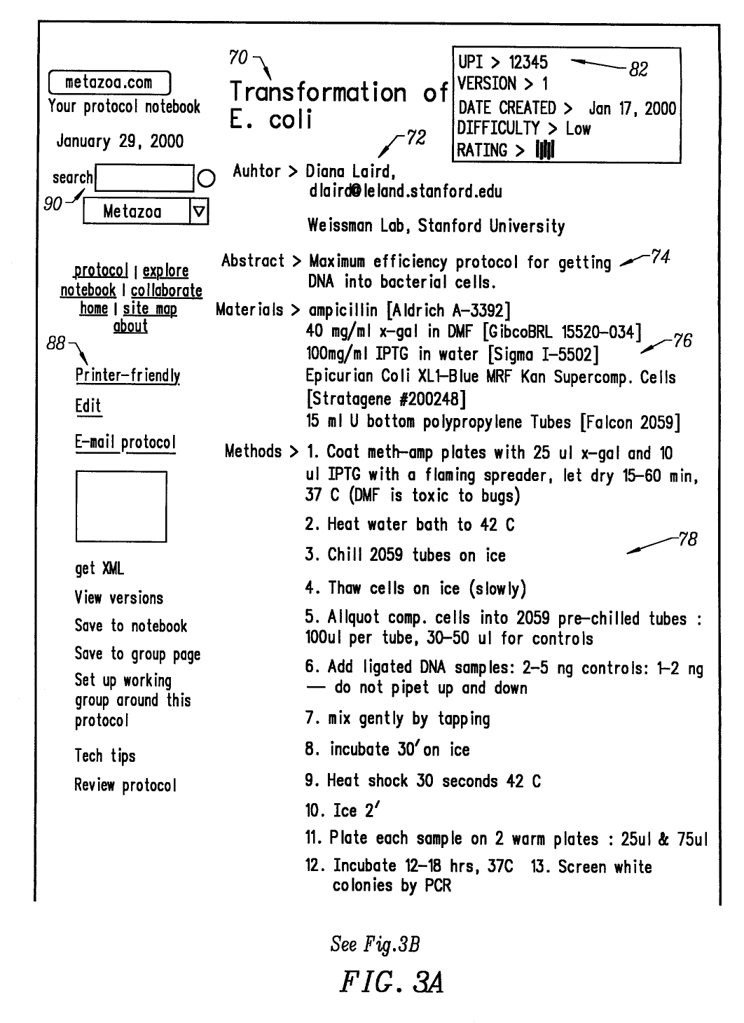

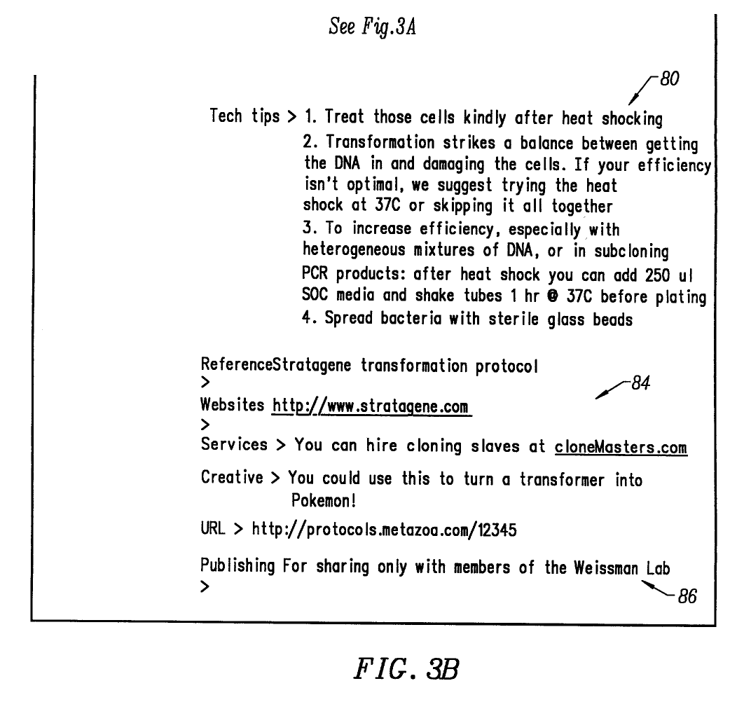

Once the protocol is entered and the UPI is assigned, it can be accessed by others if the protocol has been marked as being “visible” or available to others. A typical view of an accessed protocol is shown in the screen shot in FIG. 3. The protocol describes how to transform E coli 70, and lists author information 72, abstract 74 (a brief description of the protocol), materials needed to conduct the experiment 76, the steps of the protocol 78, and technical tips 80. In addition, the UPI 82, related web sites 84, visibility information 86, printing information 88, search window 90, as well as additional information are shown.

The UPI makes research more efficient, as it allows for easy tracking, distribution and referencing of protocols. The UPI eliminates the need to include the description of a protocol in the methods section of an article, abstract, poster, or any other presentation. The author can merely indicate the UPI number for the protocol at issue. This frees up valuable space in articles, for example. In addition, a reader can view the method represented by the UPI by simply searching for the UPI in the system of the invention. If the article is online, the reader can, for example, simply click the UPI “hot link” to take the reader directly to the protocol in the database.

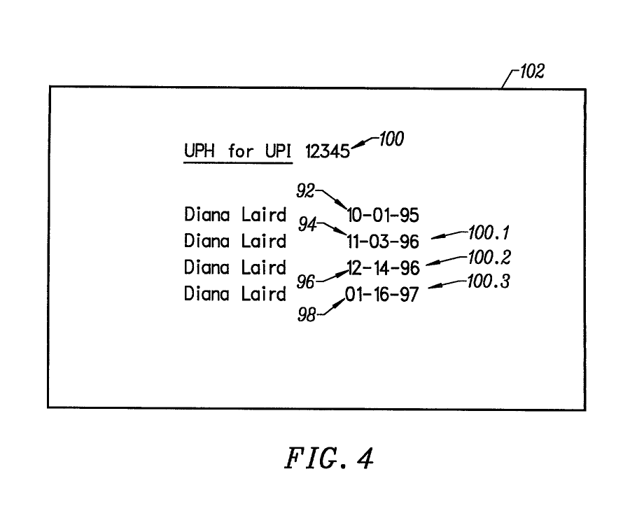

People regularly annotate protocols, but don't update the original protocol because it is too much work or impossible because they don't have access to it. The system of the invention allows protocols to be easily updated and tracked. If a scientist makes changes to a protocol that the scientist previously submitted, this is considered a protocol update. Such updates 100.1, 100.2, and 100.3 are reflected in a window 102, shown schematically in FIG. 4 and headed Unique Protocol History (UPH) for UPI 12345. The date the protocol was originally entered is shown 92. As can be seen, the date of each change, 94, 96 and 98, are noted, but the UPI 100, remains the same. If another scientist changes his protocol, this is considered an iteration and the protocol is then issued a new UPI.

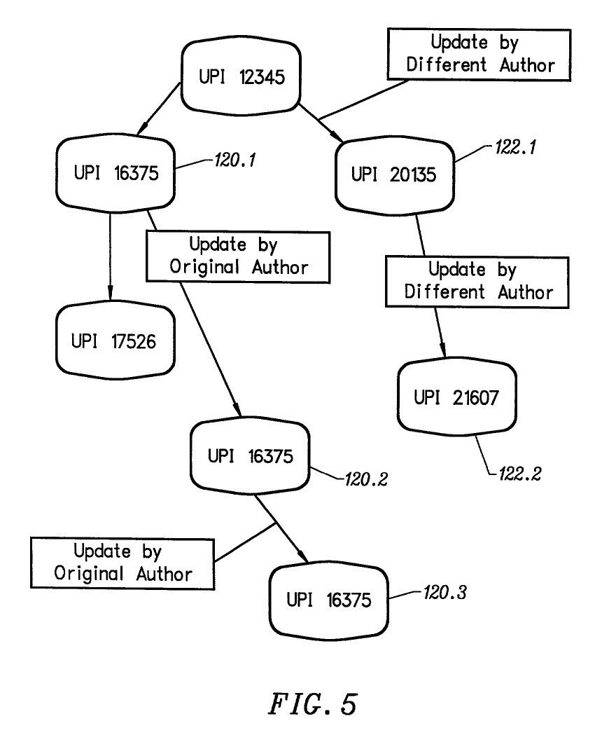

It is important for a scientist to evaluate a protocol based upon its history, regardless of whether the protocol originated with the scientist or another author. If the protocol originated with another author, the scientist can see changes that were made and choose whether to apply those changes to their research. The Unique Protocol History (UPH) provides such historical information about the protocol. In addition, companies can use the UPH to determine which employees have used which protocols. Examples of historical data that are provided by the UPH are: time criteria, authorship, versions, usage, rating and ranking. For example, the UPH can contain the original author of the protocol and all subsequent authors who made changes to it, and it will contain an “upstream” as well as a “downstream” history for each UPI. An example of this type of “upstream” and “downstream” history of a UPI is shown in FIG. 5. As discussed above, the UPI remains the same if the original author changes it. Examples of this would be the updated versions of protocol number 16375 shown by circles 120.1, 120.2 and 120.3. But a new UPI is assigned to the protocol if a different author changes it. Protocols numbered 20135 and 21607 (in circles 122.1 and 122.2 respectfully) are examples. The UPH for each protocol is presented on the face of each protocol, with links to each individual UPI in its “family tree”.

In one embodiment of the invention, a scientist can only discard protocols that have restricted visibility. Thus, when a protocol is made publicly accessible, it can not be deleted from the system. Reasons why a scientist would want to discard a restricted protocol are, for example, the protocol may have not worked or a better protocol may have been found. There are two ways to discard a restricted protocol, permanently delete the protocol from the database or make the protocol accessible as a “negative results” protocol. Defining the protocol as a “negative results” protocol allows scientists to learn from the mistakes of others. This can save time and resources. Illegal protocols can also be removed from the system of the invention by an administrator.

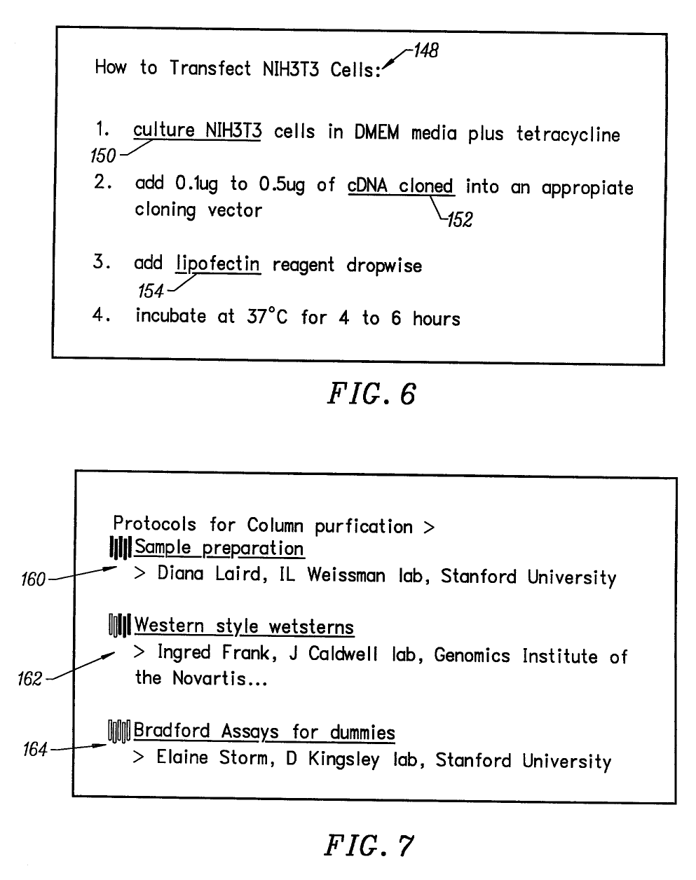

The system of the invention allows linking between related protocols and products. A protocol consists of multiple steps, within each step there are often additional protocols. Thus, protocols often include protocols within themselves. These additional protocols are often not described in sufficient detail to allow the scientist to carry out the step or steps required. For instance, a scientist, after reading a protocol, may want to access a related protocol. This can be done, using the system of the invention, by clicking on the underlined links, as shown in FIG. 6. Clicking a hypertext link of this type results in the delivery of the related protocol to the user. The protocol of FIG. 6 relates to transfecting a mouse cell line with cDNA 148. Related protocols that are linked are how to culture NIH3T3 cells 150, and how to clone cDNA 152 into a vector. In addition, one may want to order a vial of lipofectin reagent. This can be done by clicking on the word “lipofectin” 154. This purchasing aspect of the system of the invention is described in greater detail below.

Another aspect of the invention is its rating/ranking system. The rating/ranking system of the invention allows for rating a protocol, and once rated, ranking it amongst other protocols. Such a system is useful to the scientist in that it provides critical validation of a protocol. The rating/ranking system helps the scientist to distinguish which protocols are good and which are bad, resulting in saved time and money.

In addition, since author information can be presented along with the ranked protocol, a protocol ranking system will serve as a means for scientists to become known amongst their peers. For instance, a scientist whose protocols are consistently ranked high will begin to establish a good reputation. In addition, the more protocols that an individual submits into the system, the more visibility the individual receives.

The rating methodology used in the system of the invention may be based on the sum of ratings divided by the number of ratings. Rating information is input into the system with several metrics being aggregated and summarized graphically and numerically. Ratings can be built around, for example, the attributes of the person rating the protocol (their browsing history, number of publications, academic/industrial affiliations, networking/collaborations, honors, grant success rate, National Academy memberships, Nobel prizes, speed of response to inquiries, number of protocols submitted, and academic transcripts); author's own rating; author attributes (their browsing history, number of publications, academic/industrial affiliations, networking/collaborations, honors, grant success rate, National Academy memberships, Nobel prizes, speed of response to inquiries, number of protocols submitted, and academic transcripts); subsets of users defined by the user; total product cost of a protocol (compared to other versions); purchasing history; amount of purchases generated from the protocol; time it takes to use the protocol; how many versions of the protocol exist; how difficult the protocol is; how new the protocol is; interaction delta (how different it is); and how often the protocol is referred to in scientific literature.

Greater details of exemplary protocol rating parameters are presented below:

User Feedback-Scale of 1 to 5

# of other protocols positively/negatively rated;

# of well-rated protocols by user.

Author Status (Protocol Author)

University Author is at (some universities rate higher than others; could be based on U.S. News and World Reports or some other rating system);

number of publications;

number of citations;

which lab does Author belong to: National Academy member, Grant success rate, Howard Hughes Institute, Nobel Prize, McArthur Award, Number of publications, citations;

self-rating of protocol with areas noted for improvement.

Regarding the Protocol

# of hits;

Protocol history: is it based on a previously high rated protocol?

# of times it takes to get protocol to work, user feedback, number of times attempted;

# of different versions/permutations.

After the protocols are rated they are ranked. The ranking of each protocol may be displayed on the face of the protocol. The ranking, for example, can be conveyed visually to the user in the form of one to five filled test tubes 160 as shown in FIG. 7. No filled test tubes being the lowest protocol rating and five-filled test tubes being the highest protocol rating. As shown in FIG. 7, the highest ranked protocol 160 received five filled test tubes, and the lowest ranked protocol 164 received no filled test tubes. An intermediate ranked protocol 162 received three filled test tubes. Other forms of visualization, for example, a star or checkmark can be used.

The system of the invention also tracks the browsing history for a protocol. For example, the system may track one or more of the following parameters: how many times a protocol was browsed, minutes viewed, number of times forwarded to another, who browsed it, how many times downloaded, how many iterations made, how many times was it downloaded into or thrown out of someone's notebook, how much feedback received, comments posted next to the protocol and how many times the author got feedback in the form of an e-mail.

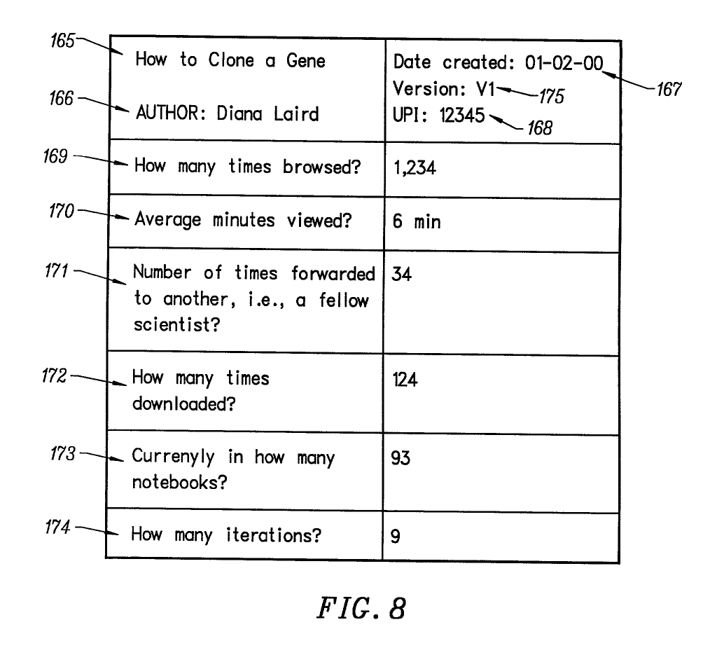

An example of a Browsing History is shown in FIG. 8. The browsing history shows information regarding the protocol, such as, name 165, author 166, date created 167, UPI 168, times browsed 169, average minutes viewed 170, number of times forwarded to another scientists 171, number of times downloaded 172, how many notebooks it appears in 173, iterations made 174 and version 175.

In addition, a company can use the browsing history as a marketing tool. For instance, a company could observe the browsing habits of a scientist and see that the scientist uses mainly Molecular Biology tools (reagents, devices, etc.) and based on this browsing history, direct specific newsletters or product information at that scientist.

Feedback is a critical element of research. An individual scientist who submits a protocol can choose to request feedback from the users of the protocol. An e-mail account can be set up for other users to send the scientist comments on the protocol. This feedback allows the scientist to improve the protocol, exchange ideas with others, and even set up collaborations with people in a similar area of research.

People can also use the system of the invention to promote their research and themselves. The system of the invention allows a scientist to select a group of professors, for example, to whom to send the new protocol as an e-mail attachment or from a link that appears on the face of the protocol. In addition, a scientist can send a new protocol to a virtual “bulletin board” in the system, where users periodically check for the latest research news. The “bulletin board” is described in greater detail below.

The user can set up an account, access people, invite or be invited to a restricted group, and access knowledge available on the Internet. In addition, the user can conduct online meetings, post information on a virtual “bulletin board” and set up virtual “booths” to promote themselves or their product. By way of example, the user can experience the system of the invention at three levels, each level having a different level of access. These levels can be characterized as follows:

1. a personal level, My Notebook;

2. a “virtual lab” level, iLabs; and

3. a worldwide level, The Library and MetaMeetings.

In FIG. 1, these three levels are those reflected by the different views, My Notebook 24, iLabs 22, and the Library 20 and MetaMeetings 26.

At each level, the researcher is able to organize protocols in a private and password protected notebook, share protocols and define who has access to them, and have fast and easy access to protocols from anywhere at anytime, regardless of location, lab or computer. These are merely examples of advantages to the researcher of the system of the invention.

Different types of information can be stored at each level of the system of the invention. Exemplary information includes: protocols, public information, information obtained from a search engine, templates, calculations, research notes, addresses of collaborators, and journal articles.

The personal level, or “My Notebook”, comprises setting up a private web space that the individual controls, sets the subject matter, and the collaborations. Information contained in an individual's private notebook can be integrated into and used in the virtual lab level (iLabs) and the worldwide level (The Library and MetaMeetings).

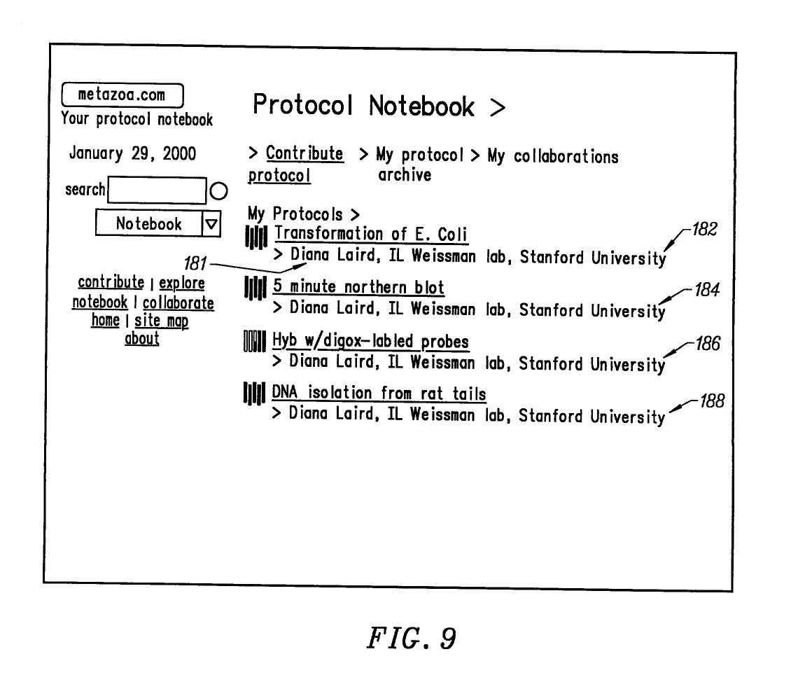

FIG. 9 is an example of the personal level, My Notebook. FIG. 9 shows the owner of the notebook 181, and four protocols, 182, 184, 186 and 188 that the researcher has saved.

My Notebook can include a function, which automatically alerts the researcher when new protocols are deposited in the system that relate to their interest. This function can be automatic (for example, based on types of protocols in My Notebook, most frequently accessed protocols, or user-defined interests), or be specified by the researcher.

A company, for example, a pharmaceutical company, can use the system of the invention as a useful management tool. For instance, the company can require each individual to have a My Notebook account on the system, wherein the notebook is accessible by the individual and the company. In this way, the company can control the flow of intellectual property into and out of the company. In addition, less time is spent getting a new employee up to speed on a project, because information regarding the project is easily accessible. The pharmaceutical company can also use My Notebook as a tool in the daily validation of research.

The system of the invention provides data security and migration, for example, when a company changes their information technology infrastructure or software. Academic labs, Universities, and other groups can also use the system of the invention as a management tool.

The “iLabs” are “virtual labs.” Each person with a personal notebook can set up an unlimited number of iLabs. The person setting up the iLab is the boss. iLabs membership is by invitation and access is password protected. The boss can select the research topics and invite others to participate. iLabs allow a select group of people to exchange information. For example, an individual interested in gene therapy could invite scientists in the same area to join the “virtual lab.” Selection of members can be based on numerous factors. One factor, for example, could be how highly ranked the individual's protocols are that appear on the system. The iLabs feature is a valuable resource to the scientist, serving as a starting point for valuable collaborations, collaborations that might not otherwise be possible due to geographical and resource restrictions.

In addition, iLabs can be used as a lab management tool. For example, the Principal Investigator (PI) of a lab can set up a Personal Notebook and define an iLab that includes the members of the lab. The PI can limit access to members of the lab. Lab members can enter their protocols into the iLab of the PI and create a lab notebook that organizes the protocols of the lab. This is useful because every time a new person joins the lab, they will be allowed access, and they can easily obtain a protocol. In addition, when people leave the lab, their protocols will stay in the lab.

The library is a repository for all public protocols and other information. It has unrestricted access, allowing anyone to obtain or exchange information.

MetaMeetings can be, for example, “virtual” conferences, chat rooms, bulletin boards, or booths. MetaMeetings can be organized, participated in, and conducted using the system of the invention. A MetaMeeting can comprise a random number of participants. Bulletin boards allow individuals to post and to read the latest research information. Companies can set up “virtual booths” on the system of the invention, advertising their products and services. This allows companies to interact directly with a wide customer base. MetaMeetings can occur in “real time,” for example, through videoconferencing.

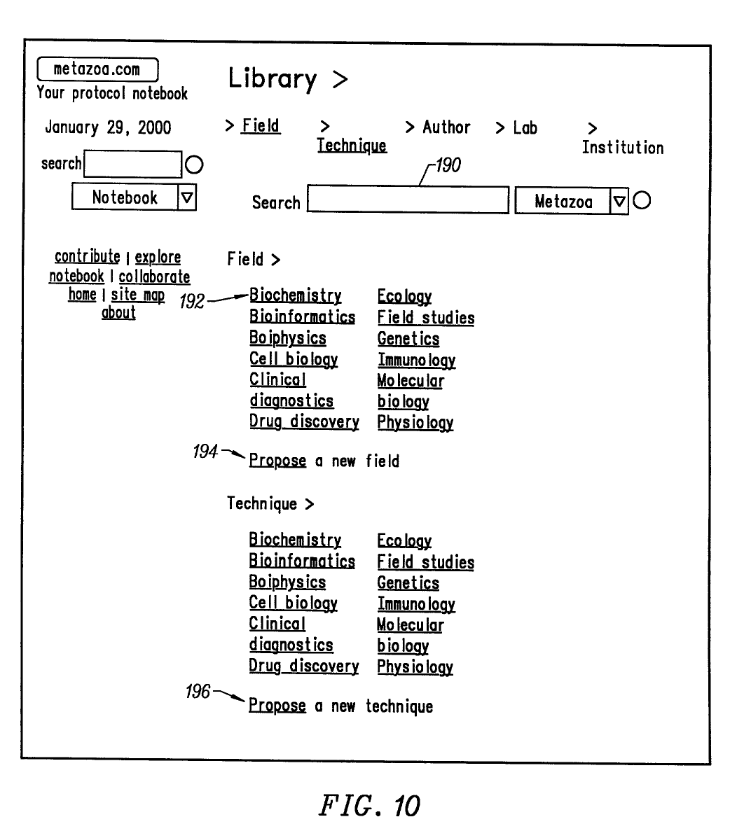

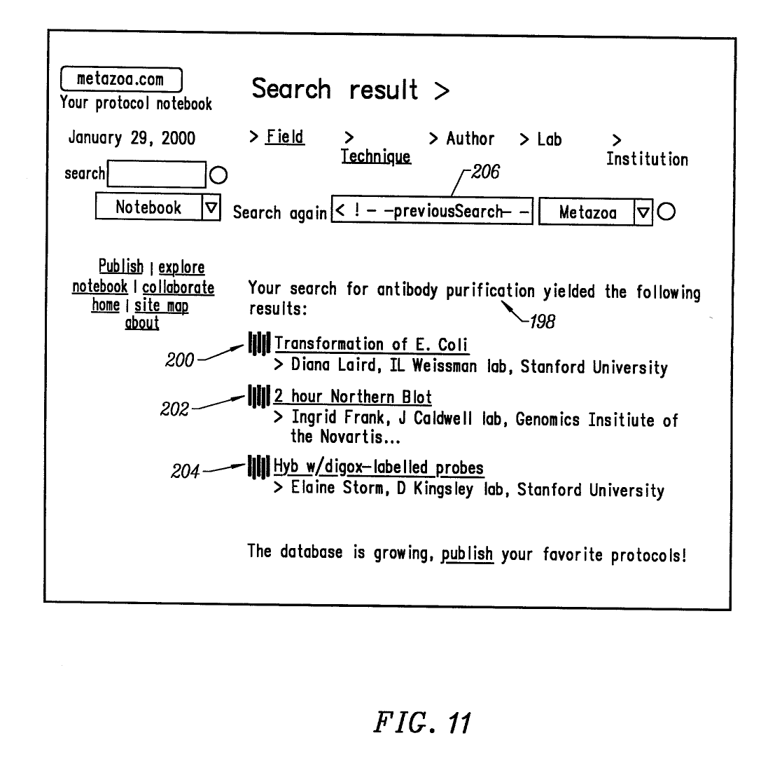

A person will be able to search the database of the system of the invention by UPI, technique, subject or field, “get creative” field, key word, author and author contact information, institution and institution contact information, year, publication and publication contact information, pages, vendors and vendor contact information, products, rating, ranking, UPI and UPH. These are merely examples of the types of searching parameters that can be used. An example of a search screen of the invention is shown in FIG. 10. The researcher types into the search box 190 the desired field, for example, biochemistry 192. In addition, the searcher can propose a new field 194 or a new technique 196. An example of a search result screen is shown in FIG. 11. The search for an antibody purification protocol 198 resulted in three protocols, 200, 202 and 204. The search can be further refined. One can also return to previous searches 206.

The invention may also be used to facilitate commercial transactions. Scientists on a daily basis purchase both products and services from numerous sources. Examples of products that a scientist buys are: reagents, antibodies, enzymes, chemicals, refrigerators, centrifuges, microscopes, mice, test tubes and PCR machines. Services that a scientist would purchase are, for example, cloning, FACS analysis or sequencing.

An example of a typical purchase process is described below. A biotechnology lab has existing supplier agreements, i.e. to suppliers like Fisher® and Sigma®. The scientist orders reagents through the supplier's Web site or off-line with a Purchase Order number. Often, ordering from Web sites is not possible and the purchasing department of the institution has to call multiple vendors to negotiate and submit orders. For expensive equipment, such as machines, the individual contacts the vendor's representative directly to get a quote. If the institution has an account with the vendor, they might offer a cheaper rate. Purchasing then “signs off” on the quote and places the order. This process can be made more efficient, resulting in less time and money wasted.

A researcher can buy products and services online using several features supported by the transaction support module 17 of the invention. Features of the system include: ‘product search’, ‘vendor search’, ‘comparison shopping’, ‘order approval’, ‘shopping cart’, ‘shopping history’, ‘list of favorites’ and ‘order tracking’.

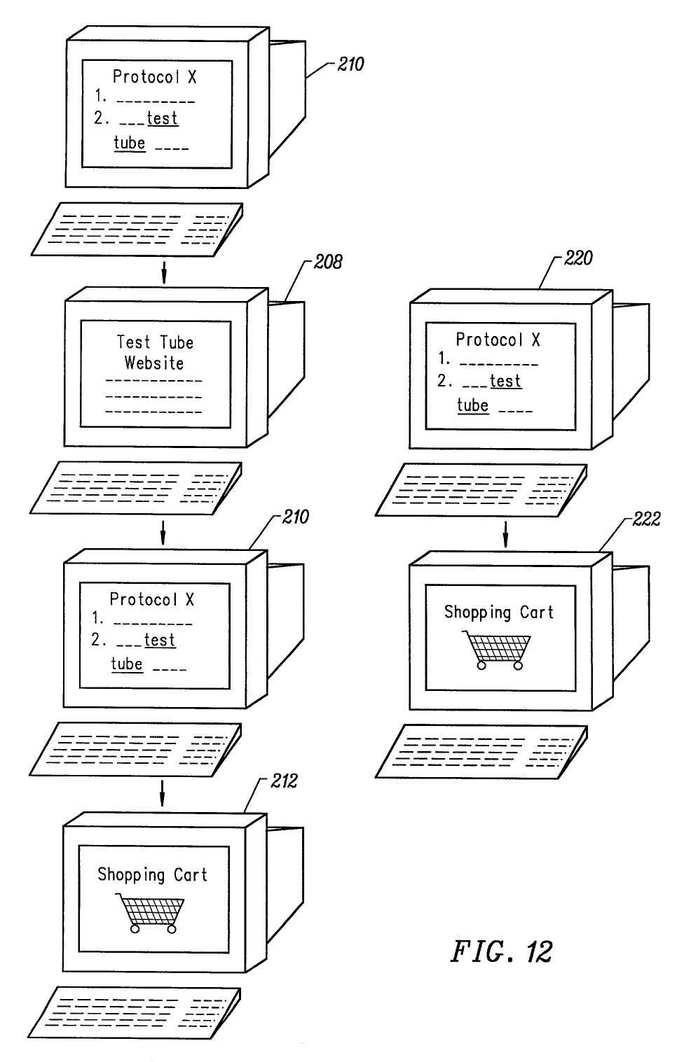

More specifically, each protocol may include links to the vendors that supply the necessary ingredients. At least two different types of links may be used. These are shown in FIG. 12. One link as shown in 208, can be to the vendor's web site, allowing the individual to obtain a further description of the product or find out what else the vendor sells. In this context, the researcher pulls up protocol X 210 on the screen of the computer, clicks on the words “test tubes” and goes directly to the test tubes vendor's web site 208. The test tubes can be purchased at the web site 208 or from the protocol X 210. The purchase can be consummated using a “shopping cart” 212 or other known e-commerce technique.

A second type of link, shown in 220, is a direct link to a shopping cart 222, without accessing the vendor's web site. Using either link, the products to be purchased can be saved as a list, which is viewed by whomever is responsible for purchasing supplies for the lab. After approval, the list can be electronically transmitted to purchasing which then orders the desired products. The system of the invention provides a link between products and purchasing systems of any laboratory. Thus, protocols drive purchasing.

As described above, the system of the invention allows an individual to order reagents from a protocol through hyperlinks in the protocol. In addition, an individual can also order a group of items, or a prepackaged group of items, for example, a kit, through hyperlinks in the protocol.

Using the system of the invention, individuals can locate, compare, and purchase products and services more efficiently. In addition, the system of the invention allows purchases to be tracked. The system of the invention automates the ordering process, consolidates orders and payments, eliminates redundancy in ordering and reduces errors in the purchasing process.

The system of the invention can help a company in several ways. For example, the system of the invention facilitates easy access to the world market, broadening a company's advertising capabilities, customer base and increasing revenues.

In addition, the system of the invention can organize a company's proprietary protocols online. For example, a pharmaceutical company can organize and standardize their protocols from different departments, sites and subsidiaries. The system of the invention can organize and allow access to all protocols from all locations within the company. In addition, the system of the invention can be in the form of software, that can be sold to companies to provide the same or a similar type of service. The system of the invention can be customized according to the needs of the individual, group or company.

The system of the invention is a valuable resource for different groups outside and inside the scientific community. For example, consulting firms, venture capitalist firms, human resources departments or newspapers, can use stored information to create reports, analyses, and the like.

The foregoing description of the system of the invention has been presented for the purpose of illustration and description. It is not intended to be exhaustive or to limit the invention to the precise form disclosed, and many modifications and variations are possible in light of the above teachings. The particular embodiments were chosen and described in order to best explain the principles of the invention and its practical application to thereby enable others skilled in the art to best utilize the invention in various embodiments and with various modifications as are suited to the particular uses contemplated.

In the claims:

1. A scientific research management system, comprising:
a scientific knowledge database to store protocol information including a set of protocols, each protocol specifying a scientific method; and
an access control module to allow a first portion of said scientific knowledge database to be accessed by a first set of users and a second portion of said scientific knowledge database, larger than said first portion, to be accessed by a second set of users, said second set of users being smaller than said first set of users.

2. The scientific research management system of claim 1 wherein said access control module allows a third portion of said scientific knowledge database, larger than said second portion, to be accessed by a third set of users, said third set of users being smaller than said second set of users.

3. The scientific research management system of claim 1 wherein said protocol information includes protocol identifiers attributed to protocols within said set of protocols.

4. The scientific research management system of claim 1 wherein said protocol information includes protocol rankings assigned to protocols within said set of protocols.

5. The scientific research management system of claim 1 wherein said protocol information includes vendor information.

6. The scientific research management system of claim 5 wherein said scientific knowledge database includes a transaction support module to facilitate a purchase from a vendor specified within said vendor information.

7. The scientific research management system of claim 1 wherein said protocol information includes cross-references between individual protocols within said set of protocols.

8. The scientific research management system of claim 1 further comprising a user interface to receive information on a specified protocol to facilitate entry of said specified protocol into said scientific knowledge database.

9. A method of managing scientific research, comprising:
receiving first protocol information from a first user, said first protocol information specifying a scientific method;
storing said first protocol information in a scientific knowledge database;
accepting a request from a second user for said first protocol information;
transmitting said first protocol information to said second user;
obtaining modified first protocol information from said second user; and
incorporating said modified first protocol information into said scientific knowledge database as second protocol information.

10. The method of claim 9 wherein said accepting includes:
identifying said second user; and
determining whether said second user is within a predetermined group allowed to access said first protocol, wherein said transmitting occurs only when said second user is within said predetermined group.

11. The method of claim 10 wherein said receiving includes accepting a predetermined group definition from said first user.

12. The method of claim 9 wherein said receiving includes assigning a first protocol identifier to said first protocol information and said incorporating includes assigning a second protocol identifier to said second protocol information.

13. The method of claim 9 further comprising receiving first protocol ranking information from said second user.

14. The method of claim 9 further comprising using said scientific knowledge database to facilitate the purchase of an item specified in a protocol stored within said scientific knowledge database.

15. The method of claim 9 further comprising linking information in said first protocol information with related information stored in said scientific knowledge database.

16. The method of claim 9 wherein said receiving includes receiving first protocol information collected from a user interface delivered to a web browser.
